(19) United States
(12) Patent Application Publication
(10) Pub. No.: US 2010/0084080 A1
(43) Pub. Date: Apr. 8, 2010

(54) PROFILE BODYBOARD

(76) Inventor: Wah Kan CHEUNG, Richmond Hill (CA)

Correspondence Address: LAW OFFICES OF CLEMENT CHENG, 17220 NEWHOPE STREET #127, FOUNTAIN VALLEY, CA, 92708, US

(21) Appl. No.: 12/627,195

(22) Filed: Nov. 30, 2009

Related U.S. Application Data
(63) Continuation-in-part of application No. 11/985,895, filed on Nov. 19, 2007, now abandoned.
(60) Provisional application No. 60/860,535, filed on Nov. 22, 2006.

(51) Int. Cl. B29C 51/00

(52) U.S. Cl. 156/213

(57) ABSTRACT

A bodyboard has an improved construction for ease of handling. A variety of different shapes and construction features allows the bodyboard a distinct yet stable performance in the water. A bodyboard has an improved construction for ease of handling. The bodyboard has a bottom finger bulb with a shallow lengthwise bottom depression and shallow rear tail depressions. The process for producing the board requires removal of foam core material, or molding the foam core in a specific shape mold to provide the profile. Rear tail depressions formed at a diagonal angle being no more than 1 cm in depth can extend from a deep portion at the tail of the board and blend into the board at approximately one-quarter of the length of the board.

This application is a continuation in part of Profile Bodyboard application Ser. No. 11/985,895 filed Nov. 19, 2007 by same inventor Wah Kan Cheung, which in turn claims priority from same inventor Wah Kan Cheung provisional application Ser. No. 60/860,535 filed Nov. 22, 2006.

### FIELD OF THE INVENTION

The present invention relates to foam sports boards for recreational use and, more particularly, to bodyboards or snow sleds having a contoured surface profile for enhancing performance or providing features such as purchase enhancing region of a bodyboard, foot stopper or a seat retainer of a snow sled.

### DISCUSSION OF RELATED ART

A variety of differently shaped bodyboards have specific features that improve handling and performance. A variety of fins attached to the bottom of the bodyboard are also known to provide steering and stability for both bodyboards and surfboards. A variety of decorative elements also appear on bodyboards. U.S. Pat. No. D345,000 to Foulke entitled Channel Rail Bodyboard shows a lower rail with a channel which is ornamental, and possibly also functional.

Also, a wide variety of patents show purchase enhancing features disposed or formed on the top of the board. For example, Brown U.S. Pat. No. 4,894,034 teaches a scoop on the top surface of the front nose end that has a concave section on the deck of the board for enhanced gripping of a rider's arm. U.S. Pat. No. 5,116,269 entitled Bodyboard With Side Grip Contour to Moran shows a pair of thumb grooves along two side edges of the top of the board. U.S. Pat. No. 5,273,470 to Sneddon entitled Bodyboard With Rider-Purchase Enhancing Regions shows elongated ridges extending diagonally across from one side edge of the top surface to the other edge of the top surface. U.S. Pat. No. 5,797,779 to Stewart entitled Bodyboard With Differentiated Topskin shows a bodyboard with top surface torso region of hourglass shape.

Enhancing purchase is a term that is used to describe improved support, position or holding of the board. The rider should have good stance, which is described as enhanced purchase.

### SUMMARY OF THE INVENTION

The present invention provides a bodyboard with improved shape and purchase enhance features for improved manipulation in ocean surfing. The bodyboard supports a rider in ocean surf and includes an elongate bodyboard foam core having a top surface, a bottom surface, a nose surface, a nose, a tail surface, a tail and elongate laterally opposed sided edges having an upper and lower side rail surface. At least one top or bottom surface has a molded contour surface. A polyolefin foam skin layer has an outer surface and an inner surface. An adhesive resin layer bonds the inner surface of polyolefin foam skin layer to the molded contour surface of the molded foam core. The contour surface includes a variety of different shapes and construction features providing for purchase enhanced region and improved manipulation of the bodyboard in wave surfing. The bodyboard may include a bottom finger bulb with a shallow lengthwise bottom depression and shallow rear tail depressions.

The bodyboard has a pair of bottom finger bulbs with a shallow lengthwise bottom depression and a pair of shallow rear tail depressions. The process for producing the board requires removal of foam core material, or molding the foam core in a specific shape mold to provide the profile as shown in the figures. A polyethylene film/foam laminate is prepared by heat laminating a sheet of polyethylene film to a sheet of polyethylene foam. A layer of adhesive resin is applied to the foam side of the film/foam laminate. The adhesive resin coated side of the resulting film/foam laminate is then heat laminated to the contour surface of the foam core. The board 10 thus shows a bodyboard with contoured profile on the deck and a bottom slick skin with a concave depression extending substantially over the rear half of the bottom planning surface, two bottom finger bulbs at the corners of the nose and two channels near the tail.

The central lengthwise bottom depression is shallow and preferably extends across the rear half of the board to the tail of the board. However it should be understood by those skilled in the art that a bodyboard in accordance with the present invention might have the lengthwise bottom depression extending substantially over the entire bottom planning surface, or extending only in a selected region, for example extending on a region of about one third of the length of board from the tail end. The central lengthwise bottom depression provides improved handling and resistance to sideways board sliding allowing better control and steering of the board in fast and powerful waves. The depth of the depression is preferably between 3 mm and 15 mm deep. The depression preferably extends lengthwise across about third-quarter of the width of the board.

The bodyboard 10 has bottom finger bulbs with a shallow lengthwise bottom depression and shallow rear tail depressions. The features on the bottom of the board can be combined with features on the top of the board providing synergistic handling effect. For example, the top of the board may be generally flat merely having chamfered edge in its simplest form. Or the top may be contoured with various patterns of ridge and valley regions to form purchase enhance regions on the board.

Referring to FIG. 6 and FIG. 7, the present invention provides an improved sports board 10 comprising a polyolefin foam layer 161 having an outer surface 17 and an inner surface 18, a molded plastic foam core 88 having top surface 24 and bottom surface 25, and an adhesive resin layer 201 bonded to the inner surface 18 of the polyolefin foam layer 161 and the top surface 24 of the plastic foam core 88. The polyolefin foam 161 may comprise polyethylene foam and polypropylene foam. The plastic foam core 88 may comprise expanded polyethylene foam (EPE), expanded polypropylene foam (EPP), expanded polystyrene foam (EPS) and blends of the foregoing. The sports board may further comprise layer (72) of polyolefin sheet heat bonded to the outer surface of the polyolefin foam layer (71), wherein the polyolefin sheet may comprise polyethylene sheet or polypropylene sheet.

Accordingly, the general objective of the present invention is to provide an improved sports board in which different polyolefin materials may be used in the layers without loss of bond strength. Another objective is to provide an improved sports board with contoured surface with enhanced gripping and performance and can be fabricated using a less expensive laminating method at a higher production output. Another objective is to provide a method to adhere a foam skin to a preformed and preshaped foam core with distinct contour on at least one major surface of a foam board.

Bodyboards for riding waves and other recreational sports boards made of foam or other floatational material are known in the prior art. In general, such boards are composed of a number of polyethylene foam and polyethylene film layers that are laminated together by heating the layers as they are passed through nip rollers. The nip roller may be heated or unheated. This heating process causes adhesion by the localized collapse and bonding of the foam cells on the surface of the respective layers. The resulting laminate of the polyethylene foam and polyethylene film is then often heat laminated onto a standard foam core.

Because the standard foam core does not have a perfectly flat or planar surface, adhesive contact between the film and foam core is limited to the apexes of the cells on the surface of the foam core. Thus the point of contact is not uniform between the film and foam, but instead the film contacts the points of the outer surface of the core that protrude from the irregular cellular surface of the foam core.

Conventional film lamination methods typically use micro-cellular high-density foam sheets to improve the adhesion between the film and foam core. The micro-cellular foam sheet contains smaller peaks and valleys, with the peaks closer together. The surface area of contact between the sheet and foam is thereby increased. However, this kind of structure is still prone to delamination by mechanical contact forces and by the effect of heat and pressure when in use.

While it is known in the prior art that a thin layer of thermal plastic polyethylene film between a polyethylene foam sheet and a polyethylene film can be used to promote lamination, such thin layer of film is generally an unmodified low-density polyethylene with limited efficacy.

U.S. Pat. No. 5,647,784 to Moran describes making a typical composite bodyboard including an intermediate bonding film layer between a polypropylene foam core and at least one of upper and lower skin layers, which has different chemical composition from the foam core material. Preferably, the intermediate layer is a terpolymer based on polyethylene vinyl acetate and in the form of a thin, slit-film bonding adhesive. In the thermo lamination process, the film melts and acts as glue between the different materials of composite bodyboard.

U.S. Pat. No. 5,275,860 to D′Luzansky, et al. shows bodyboards and the like where the board comprises a closed cell foam core of polypropylene, a lower and upper skin of polyethylene and an intermediate layer heat bonded to each of the upper and lower skin. With the presence of intermediate layer which is a mixture of 65% polypropylene and 35% polyethylene, the peel strength between the foam core and each of upper and lower skin is improved. Multi-layered bodyboards and methods of manufacture are well known in the art and one of such boards is described in my application Ser. No. 10/797,995 titled “Multi-layered Sports Board” filed on Mar. 11, 2004 and is incorporated herein by reference.

Bodyboards and snow sleds made of foam material in general consist of a planar deck surface. It is obviously desirable to have contour profile built into the board at the opposite surface to the deck. It not only enhances the aesthetic appeal of the sports board, but also provides features such as purchase enhancing region of a bodyboard or a snow sled. Accordingly, there is need for adhesively bonded bodyboards with improved bonding between layers of different polymeric material having different surface contouring and cellular structure. Therefore, the primary object of the invention is to improve the performance, handling and construction of the body board.

### BRIEF DESCRIPTION OF THE DRAWINGS

FIG. 1 is a perspective view of the bottom of the board according to the present invention.

FIG. 2 is a top view of the board.

FIG. 3 is a cross section of the nose of the board.

FIG. 4 is a cross section of the middle of the board.

FIG. 5 is a cross section of the tail of the board.

FIG. 6 is a partial vertical sectional view of the bodyboard shown in FIG. 1.

FIG. 7 is an enlarged cross section view of the nose of the board indicated by the circle area in FIG. 3.

FIG. 8 is a schematic showing the process by which a foam skin layer is laminated to an adhesive resin layer.

FIG. 9 is a diagram showing a top lamination process that utilizes a pair of nib rollers and hot air blowers.

FIG. 10 is a diagram showing a top lamination process that utilizes a roller.

FIG. 11 is a diagram showing a top lamination process that utilizes a press.

FIG. 12 is a diagram showing the nose ridge and side gripping ridge profile features of the body board.

FIG. 13 is a diagram showing the elbow wells and leg depression profile features of the body board.

FIG. 14 is a diagram showing the elbow pads and hand grip profile features of the body board.

Embodiments of the invention will now be described by way of example with reference to the accompanying drawings. Like reference numerals identify the same structural elements, portions or surfaces, consistently throughout several drawing figures. Elements, portions or surfaces may be further described or explained by the entire written specification, of which this detailed description is an integral part. Unless otherwise indicated, the drawings are read (e.g., cross-hatching, arrangement of parts, proportion, degree, etc.) together with the specification, and are a portion of the entire description of this invention.

### DETAILED DESCRIPTION OF THE PREFERRED EMBODIMENT

The invention shows a new process of making a foam sports board such as a bodyboard for use in riding water waves, or a snow sled for use on snow slopes. The board may also be part of a sporting device such as a surfboard, snowboard, ski, gliding board or flotation device. Skilled artisans can readily expand this list to include other known foam applications.

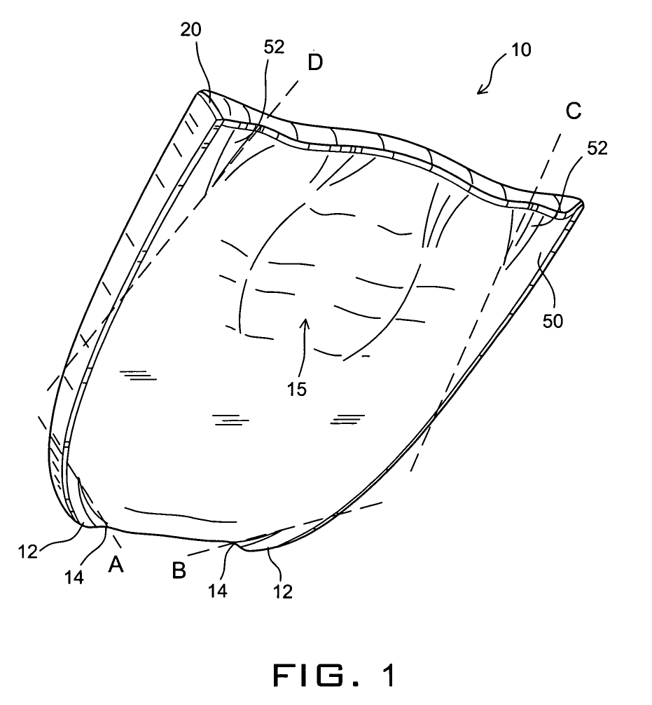

FIG. 1 shows the bottom of a bodyboard 10, as a person underwater would see the board. The front part of the board or the nose 60 faces toward the bottom of drawing and the top part of the drawing features the tail. The middle portion of the board 10 has a shallow depression 15 that runs lengthwise from about the middle part of the board to the rear part of the board. The depression 15 is formed in the core material 88 and comprises a single depression that is gradual and smooth with the bottom of the board. The bodyboard 10 has both a bottom finger bulb 12 that has an elongated profile and the bodyboard 10 also has a gradual shallow lengthwise bottom depression and shallow rear tail depressions. The process for producing the bodyboard 10 requires molding of foam core material to provide the profile as shown in the figures.

The shallow bottom depression 15 preferably extends centrally lengthwise from about one half of the board length to the tail of the board. According to a first embodiment, the shallow depression preferably extends across at least one-third of the middle width of the board. The depth of the shallow depression is preferably between 3 mm and 15 mm and is preferably approximately 6 mm deep at the deep area that is in the middle of the width of the board. The shallow depression is preformed in the core of the board and a plastic bottom slick skin is then bonded to the core such as by an adhesive film layer.

As can be seen in FIG. 1, lines A and B on diagonal angles show the hand depressions 14 of the left and right bottom finger bulbs 12 oriented diagonally. One of the bottom finger bulbs 12 forms a left grip that corresponds to the rider's left hand. The left grip line A is oriented to the right, and in the right grip line B is oriented to the left. Each finger bulb has a triangular area protrusion defined by a side edge of the lower rail surface, and a nose edge extending at a negative angle from one corner to the horizontal portion of the nose edge and a diagonally oriented hand depression line. The protrusions of the bottom finger bulbs 12 from the nose wedge provide diagonal oriented hand depressions along lines A and B.

The tail depressions similarly provide stability for the board and are oriented outward such that the right tail depression is oriented diagonally to the right and the left tail depression is oriented diagonally to the left. As can be seen in FIG. 1, lines C and D on diagonal angles show the diagonal orientation of the right and left tail depressions 52. Lines C and D are parallel to the right and left tail depressions. Lines C and D are drawn through the central deep part of the right and left tail depressions 52. Preferably, the pair of rear tail depressions is formed on the bottom side with each tail depression extending from a deep portion at the tail of the board adjacent to a side edge. Each tail depression preferably blends into the board at approximately one-quarter of the length of the board. The deep portion need not be no more than 1 cm in depth.

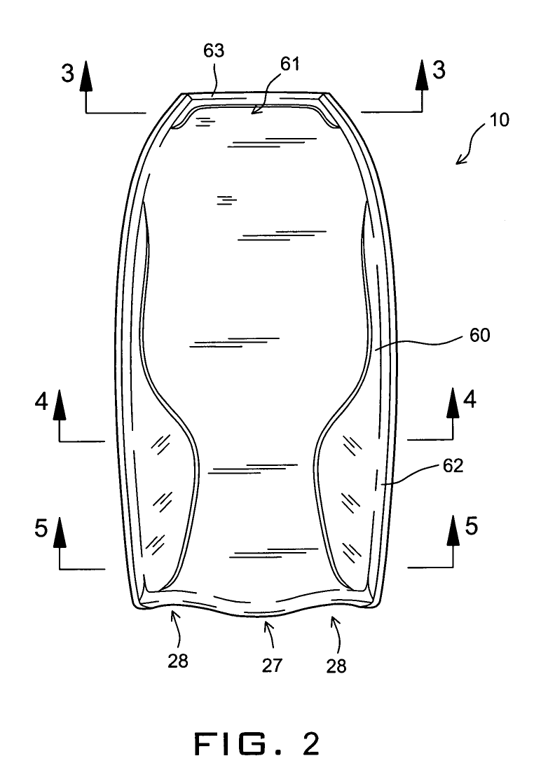

As can be seen in FIG. 2, a three section views shows the shape of the sports board 10 at a front part, a middle part from about one-quarter of the board length from the tail end and a rear part. The front of the board 61 has a front beveled surface 63, or called nose surface. The side of the board has a side beveled surface 62, or called upper rail surface, and the rear of the board 27 has a pair of tail end recess 28. Such configuration in the rear of a bodyboard is typically called a bat tail.

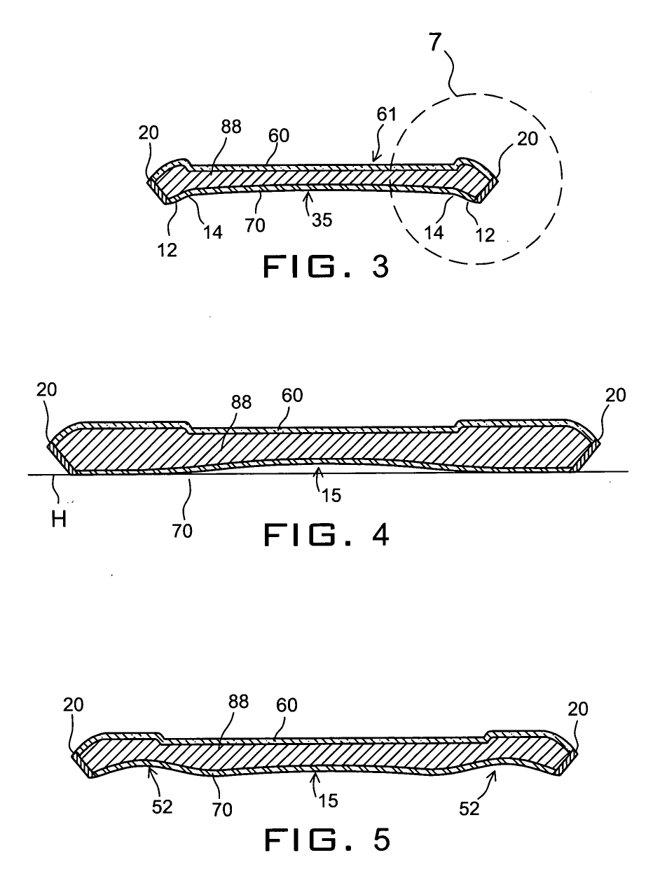

FIG. 3 shows the nose of the board core 88 surrounded by a top skin 60, a bottom skin 70, and side lower rail skin 20. The nose of the board has a nose wedge 35 shape preferably formed by removal of material in the middle top portion of the nose. The material removal forms bottom finger bulb hand depressions 14 at a triangular profile, leaving a protruded bottom finger bulb grip 12. The profile deck has a flat area bounded by ridges on the left and right.

FIG. 4 shows the middle of the board core 88 surrounded by a top skin 60, a bottom skin 70, and side rail skin 20. The shallow depression 15 forms a visibly arched profile for the bottom of the board when the board is placed on a flat horizontal surface denoted by line H. The deep portion of the board is seen in the middle of the board.

FIG. 5 shows the tail of the board core 88 surrounded by a top skin 60, a bottom skin 70, and side rail skin 20. The bottom of the board includes the shallow depression 15 in the middle of the board, flanked by rear tail depressions 52 on the left and right sides. The board core 88 is preferably molded using standard EPS molding technology.

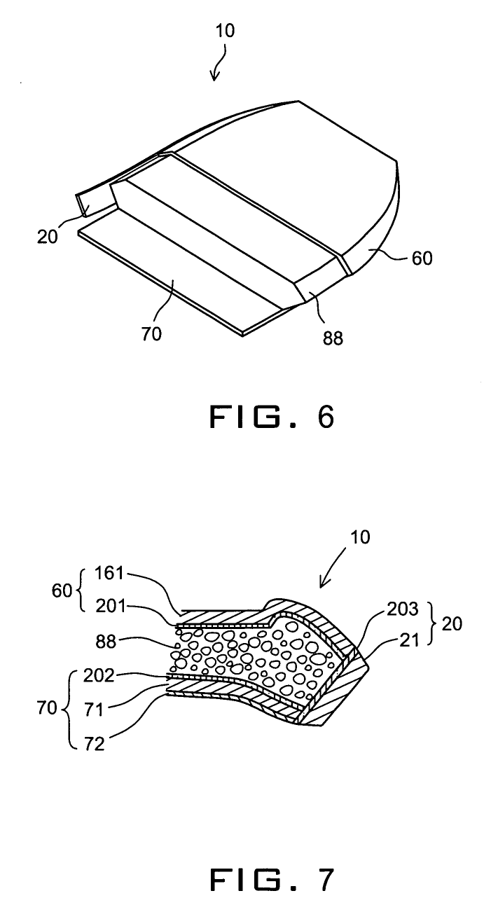

FIG. 6 shows an assembly view of an improved contoured sports board 10. The lower rail skins 20 , top skin 60 and bottom skin 70 comprise foam sheet coated with adhesive resin and heat laminated to the foam core 88 by conventional heat lamination method as described above.

FIG. 7 shows a cross-section of the present invention which shows the improved bodyboard. The bodyboard 10 is comprised of six layers laminated and thermoformed together. Top skin 60 comprises top polyolefin foam sheet 161 and adhesive layer 201. Top polyolefin foam sheet has a thickness of between 2 mm to 8 mm, and preferably a thickness of 4.5 mm. Top polyolefin foam sheet 201 has a density in the range of 4 to 10 lbs/ft³, and preferably a density of 7 lbs/ft³. The polyolefin foam sheet 161 accordance with the invention comprises a polyolefin including homopolymer or copolymer of polyethylene and polypropylene, preferably polyethylene. Most preferably, the polyethylene comprises low density polyethylene (LDPE). Useful polyethylene includes crosslink polyethylene and non-crosslink polyethylene.

Adhesive layer 201 is an ethylene and methyl acrylic copolymer. Adhesive layer 201 has a thickness of between 0.02 and 0.15 mm, and preferably a thickness of 0.07 mm. Adhesive layer 201 has a density in the range of 0.09 to 0.98 g/cm³, and preferably a density of 0.95 g/cm³. The ethylene methyl acrylate copolymer EMAC that can be obtained at Eastman Chemical Company of 100 North Eastman Road, Kingsport, Tenn. 37662 may be employed in the preferred embodiment of the present invention. Alternative adhesive resins, such as copolymer of ethylene with propylene, butene, hexene, octene, vinyl acetate, vinyl acetate and methyl acrylic, anhydride-modified polyolefin, including anhydride-modified ethylene vinyl acetate, anhydride-modified ethylene acrylate, anhydride-modified low-density polyethylene, and anhydride-modified linear low-density polyethylene, may be employed. The Bynel® adhesive resin, provided by Dupont Packaging, of 1007 Market Street, Wilmington, Del. 19898, may be employed in such an embodiment.

Foam core layer 88 is a molded foam. In the preferred embodiment, the foam core 88 is polystyrene foam. However, it is contemplated that other types of foam may be used, such as polyethylene, polypropylene foam, ethylene vinyl acetate foam, Arcel foam, polyvinylchloride foam and polyurethane foam. Layer 88 has a thickness of between 0.25 inch to 3 inch, and preferably a thickness of 1 inch to 2 inch. In the preferred embodiment, layer 88 is polystyrene foam and has a density in the range of 1.0 to 2.5 lbs/ft³, and preferably a density of 1.5 lbs/ft³ which is preferred for rigidity if the foam core thermoformed face operates as a mold die against a rigid forming mold. If polypropylene foam is used, layer 23 would have a density in the range of 1.5 to 3 lbs/ft³, and preferably a density of 1.9 lbs/ft³, which again is preferred for rigidity when the foam core thermoformed face operates as a mold die against a rigid forming mold. If polyethylene foam is used, layer 88 would have a density in the range of 1.6 to 4 lbs/ft³, and preferably a density of 2.2 lbs/ft³.

Bottom skin 70 comprises bottom polyolefin sheet layer 72, bottom polyolefin foam sheet 71 and adhesive layer 202. Bottom polyolefin sheet layer 72 is preferably a polyethylene sheet with a thickness of between 0.05 and 1.5 mm, and preferably a thickness of 0.45 mm and a density in the range of 0.91 to 0.98 g/cm³, and preferably a density of 0.95 g/cm³.

Bottom polyolefin foam sheet layer 71 is of the same structure and composition as layer 161.

Adhesive layer 202 is of the same structure and composition as layer 201.

A pair of side rail skin 20 comprise polyolefin foam sheet 21 and adhesive layer 203. Lower rail polyolefin foam sheet covers the lower rail surface of the board and is of the same structure and composition as layer 161. An adhesive layer 203 may also be applied to bond the lower rail polyolefin foam sheet 21 to the lower rail surface of the foam core 88.

It is desirable to improve the gripping property of the top foam sheet of the sports board. One method to achieve a higher coefficient of friction of the top foam sheet is by blending the polyethylene or polypropylene with some elastic polymer characterized with more flexible polymer chain structure such as ethylene vinyl acetate (EVA) and ethylene butyl acrylate (EBA). The addition of elastic polymer into polyolefin generally makes the foam sheet more resilient and softer to grasp.

Another method of increasing the coefficient of friction of the top foam sheet is to apply a film to the outer surface of the polyolefin foam sheet. The film has a higher coefficient of friction than the foam sheet. The film preferably has a thickness ranging from about 0.02 mm to about 0.4 mm, more preferably between about 0.07 mm and 0.15 mm. The film may comprise at least one member selected from ethylene/styrene interpolymer, ethylene/propylene rubber, homogeneous ethylene/alpha-olefin copolymer, ethylene/vinyl acetate copolymer and other thermoplastic elastomer, and blends of the foregoing. The film may be applied to foam sheet by any conventional processing technique known in the industry. The film may be extruded in a molten state onto a surface of the polyolefin foam sheet, whereon the film solidifies and adheres to the foam sheet surface. Such a process is typically known as extrusion coating.

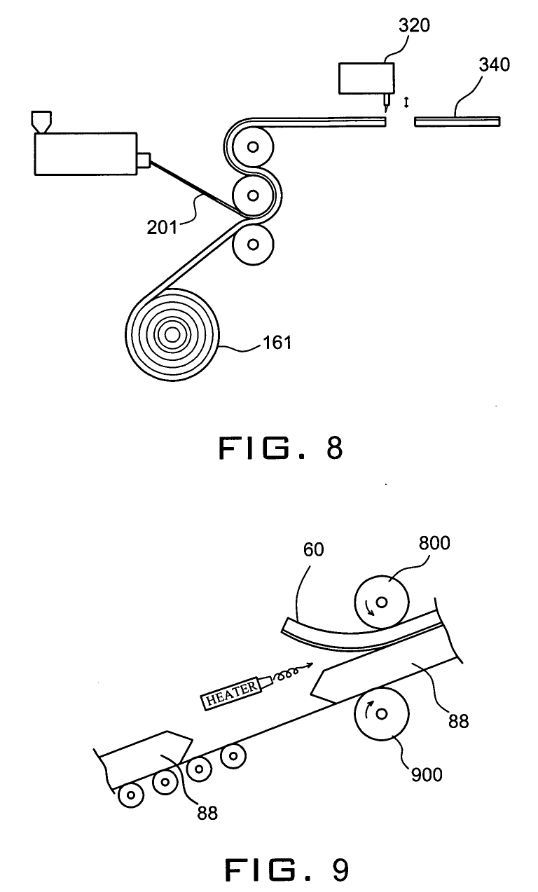

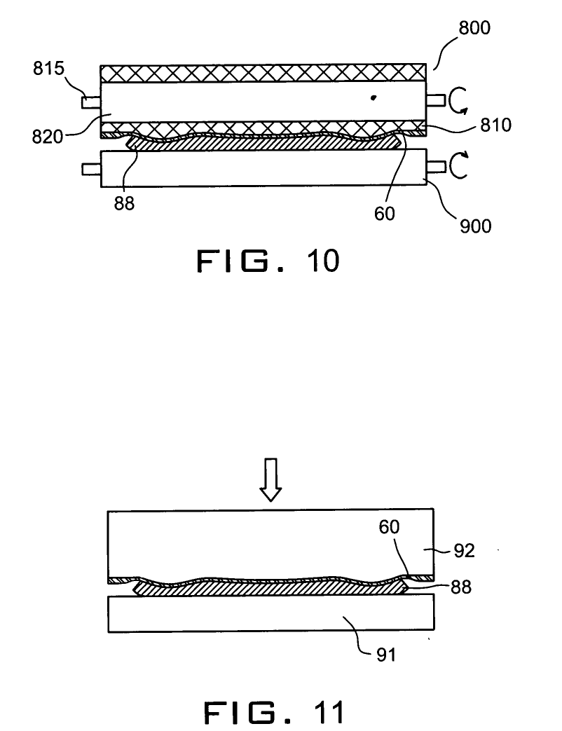

FIG. 8 shows the lamination process of the top skin portion 60 by applying a thin film of adhesive resin 201 on one surface of a polyolefin foam sheet 161 using conventional film extrusion coating process. The polyolefin foam may comprise homopolymers or copolymers of polyethylene (PE) foam and polypropylene (PP) foam. The polyolefin foam layer 161 is fed into rollers and adhesive resin such as a layer of ethylene methyl acrylate copolymer 201 can be extruded and applied to the foam layer 161. A cutting device 320 separates the continuous roll into sections of preferably rectangular sheets of laminate top board 340 comprising adhesive resin 201 and foam sheet 161. FIG. 9 shows that rectangular sheets of laminate top board 340 can be used as a top layer 60 and heat laminated to the core 88 between a top roller 800 and a bottom roller 900.

The foam core 88 of the present foam sports board may take the form of any foam board known in the art such as molded expanded polystyrene (EPS) foam and expanded polyolefin foam and polyurethane foam. Polyolefin foams useful as the foam core include homopolymers and copolymers of ethylene, propylene and ethylene vinyl acetate as well as a wide variety of blends with one or more such homopolymers and copolymers. Expanded polystyrene (EPS) and expanded polypropylene (EPP) are particular preferable material for the foam core due to high rigidity to weight ratio. The foam core with the desirable contoured surface profile can be made by any conventional method known in the art. Useful fabrication methods include machining by hand or shaping equipments. More complicated profile shape may be applied to a foam plank by computerized shaping machine such as CNC programmed milling machine. Most preferably, the foam core is made by the conventional molding method of foam beads. The molded foam core has a thickness that is desirably from 0.25 inch to 3 inch, preferably form 1 inch to 2 inch.

The present invention is particularly useful with molded EPS foam core. Such foams are stiff and light weight and have relatively lower material cost. The EPS foam core substantially enhances the flexural strength of the sports board while the polyethylene foam skin provide a soft touch, resilient and comfortable riding deck surface.

In one embodiment, the foam skin is a polyolefin foam sheet. The polyolefin foam skin may be homopolymers and copolymers of polyethylene and polypropylene. The foam sheet may be a monolayer structure or a multilayer structure. In a multilayer structure, the foam sheet may be a laminate of two or more foam sheets.

In another embodiment, the foam skin is a laminate of polyolefin foam sheet and polyolefin film and the polyolefin film is the surface film. The polyolefin film preferably has the same polymer composition as the polyolefin foam sheet. The polyolefin foam sheet may be a monolayer structure or a multilayer structure. The film/foam laminate may be prepared via conventional film extrusion and the foam sheet is applied and heat bonded to the hot extrudate of film. The surface film may be in the form of a monolayer film, a multiple-layer film, or a co-extruded multilayer film. The monolayer film or multiple-layer film can be coated with a layer of adhesive resin to enhance the bonding between the film and the foam sheet layers. The surface film may also include a graphic image imprinted on it and the image is visible outside the board for decorating the board. Similar to the preparation of the top foam skin 60, an adhesive layer is applied to the polyolefin foam sheet surface of the polyolefin film/polyolefin foam laminate (72/71) to form the final bottom foam skin 70.

Sneddon in U.S. Pat. No. 5,273,470 incorporated herein by reference describes a bodyboard with rider purchase enhancing regions. The complex structure includes a purchase enhancing region including plural ridges extending diagonally across the region to improve rider stability. In the prior art, a surface pattern for gripping in bodyboard is generally first thermoformed on the top surface of a foam skin which is then heat laminated onto a foam core having a substantially planar receiving surface. For contoured deck bodyboard fabrication, desirable configuration of foam core is conventionally shaped or grinded by hand and machine out of a foam plank. Gripping features such as an elbow well that forms a depression below the level of planar deck surface of foam core requires removal of material. On the other hand, gripping features such as a gripping ridge that form a protrusion above the level of planar deck surface is typically made by laminate a foam piece on top of the foam plank in the required location and carefully shaped to the final configuration by detail hand shaping. A foam skin is then heat laminated to the resulting foam core with depressed or protruded gripping contour on the deck surface. Due to the non-planar nature of the contour deck surface, heat lamination process always requires hand pressing to bring the foam skin in immediate contact with the contoured foam core surface. Therefore it requires a lot of labor and handwork to make a contoured deck bodyboard.

In the present invention, the desirable contour of molded foam core can be formed by conventional foam beads molding techniques. Distinct depressions and raised areas can be made for enhancing performance or providing features such as purchase enhancing region of a bodyboard, foot stopper or a seat retainer of a snow sled. A foam skin is then heat laminated to the molded foam core. Intimate contact between the foam skin and the contoured surface of the foam core is facilitated by a elastic nip roller on the foam skin side so that the foam skin can be press fit into the depressed area and conform with the profile of the molded foam core. Therefore the present invention provides a system to fabricate contoured deck bodyboard at a lower production cost and a higher production output.

FIG. 9 shows the heat lamination process of the top skin 60 to the molded foam core 88 made of material such as expanded polystyrene commonly known as EPS. Any conventional heating process can be applied to the top skin 60 and the foam core 88 including radiant heat, infrared heat, hot air or similar heating methods. Preferably the nip roller on the foam skin side is made of a resilient material that can conform to the contour of the foam core surface when pressing the foam skin against the core surface.

Suitable resilient materials for the nip roller include those rubber compounds known in the art. Illustrative rubber materials include neoprene, nitrile, EPDM, silicone, polyisoprene, polyurethane, viton, hypalon and blends of the foregoing. Other natural or synthetic rubber may also be used as long as the material has good flexibility and shape recovery properties. Preferably the resilient material is made of a blend of neoprene and nitrile rubber. More preferably the rubber material should be expanded to produce a lower density rubber foam which has the required properties of softness, resilience and quick recovery upon deformation. Such an expanded rubber materials are also called rubber sponge or cellular rubber.

An elastic nip roller can facilitate intimate contact between the top foam skin and the contoured foam core. Then the core can be reversed and the unlaminated side heated and a sheet of film/foam laminate is similarly laminated thereto and forms the slick bottom skin of the bodyboard. The bottom skin of the finished product usually comprises a low friction polyethylene film with backing foam sheet which is usually high density polyethylene foam. The slick bottom surface allows a user to glide over water or snow.

FIG. 10 shows a top nip roller 800 having a rigid core 820 enveloped in an exterior softer layer 810 that rotates about axle 815. The roller 800 resilient exterior softer layer 810 is preferably made of a rubbery material such as an elastomeric plastic. The roller 800 rolls over the bottom deck profile of the body board core 88 and rolls a laminate layer 340 onto the core 88. The nip roller produces a contoured surface having a thickness generally in the range of 0.125 inch to 1 inch depth variation.

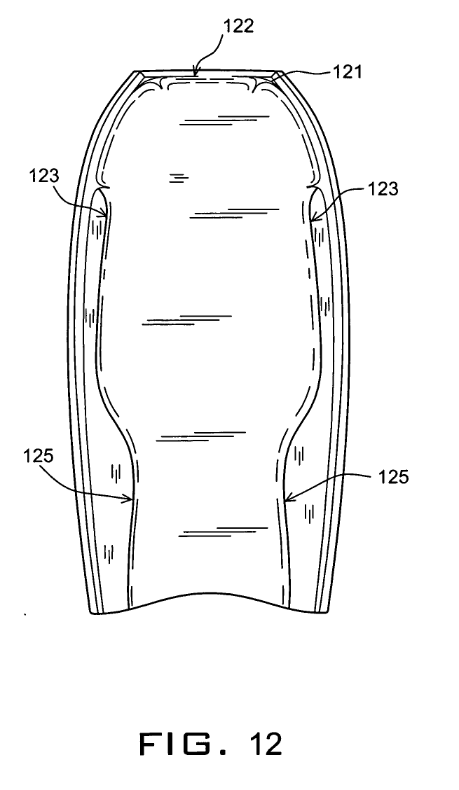

A press mold also called a compression press can be used. FIG. 11 shows that the heat lamination process can also be a compression press tooling with a compression mold top portion 92 pressing down on the compression mold bottom portion 91. The foam core 88 is similarly precontoured having a profile and now receives a laminate surface 60 having a profile. The compression mold, also called a press mold, has a top portion 92 matches the foam core 88 profile. Again, the laminate layer of foam sheets 340 adheres to the foam core 88 via heat and pressure.

A variety of body boards can be made using the above described processes. As seen in FIGS. 12, 13 and 14 the principal features of the contoured profile deck comprises a hand-hold in the nose 61 such as a nose gripping node 121, a nose ridge 122, a hand-hold along the two side edges such as side ridges 123, side gripping grooves 124, hip lock ridges 125, leg depressions 126, an elbow retainer well 127 and an elbow pad 128.

Nose gripping nodes 121 is a pair of triangular protrusion on the top surface at two corners of the nose end and upper beveled edge to provide a handhold. Each gripping node is a triangular area defined by an edge of the upper rail surface, upper edge of the nose surface and a diagonally oriented line on the top surface. One surface of the node forms a continuation of the upper edge of the upper rail surface and another surface of the node forms a continuation of the upper edge of the nose surface, extending to the apex of the node which is above the top surface of the board at preferably between about 3 mm and about 12 mm.

The nose ridge 122 is a raised area adjacent to the nose preferably elongated and inhibiting the thumb from slipping toward the outside and off the nose edge when the nose ridge 122 is gripped. The nose ridge 122 is a wedge shaped ridge protrusion extending along selected regions of the nose end to provide a handhold, and one side of the ridge forms a continuation of the upper edge of the nose surface extending to the apex of the nose ridge which is above the top surface of the board at preferably between about 3 mm and about 12 mm.

Side grip ridge 123 is an elongated raised area adjacent to the upper side edge of the upper rail surface generally from the nose to one half the board length, wherein one side of the ridge forms a continuation of the upper side edge of the upper rail surface which extends to the apex of the ridge, the apex characterized by having a elongate flat surface having a width in the range of about 5 mm to about 50 mm and the apex extending above the level of the top surface of the board in the range of about 3 mm to about 12 mm.

Side gripping grooves 124 provide a handhold, each groove forming a depression below the level of the top surface of the board and sized to receive a rider's thumb, wherein each groove extends along selected regions of the top surface adjacent to the upper side edge of the upper rail surface from the nose to about one half the board length, wherein a depression depth of each groove is in the range of about 3 mm to about 12 mm, wherein the width of depression is in the range of about 20 mm to about 65 mm, wherein the bottom of depression is spaced from the side edge of the top surface in the range of about 18 mm to about 40 mm.

The hip lock ridges 125 prevent undesirable lateral movement of rider's lower torso and hip away from the board. Each hip lock ridge extending along selected regions of the top surface adjacent to the side edge of the top surface from the tail to about one half the board length, wherein one side of the ridge forms a continuation of the upper side edge of the upper rail surface which extends to the apex of the ridge, wherein the apex has an elongate flat surface having a width generally in the range of about 5 mm to about 50 mm and the apex extending above the level of the top surface of the board in the range of about 3 mm to about 12 mm.

Leg depressions 126 aid the withdraw of rider's legs when shifting from a prone to a dropknee riding position, wherein each leg depression of the pair of leg depressions extends from a deep portion at the tail of the board adjacent to a side edge and blends into the board at approximately one-quarter of the length of the board, wherein the deep portion is no more than 1 cm in depth.

The elbow retainer wells 127 enhance purchase of the rider's elbow, the elbow well being ergonomically contoured and sized to receive rider's elbow extending along selected regions of the top surface adjacent to the side edge of the top surface generally from the nose to one half the board length, characterized by a well of depressed area surrounded by perimetric region at a higher level than the well, depth of well relative to the perimetric region being in the ranges from 3 mm and 12 mm.

A pair of elbow pads 128 should be formed as two raised perimeter sections along the upper half portion of the riding surface adjacent opposite side edges of the bodyboard, extending from the nose to about half length of the board. The raised area of the pads may continue and connect with the side gripping ridge, nose ridge and the nose gripping nodes in the upper half of the board, or may continue and connect with the hip lock ridge in the lower half of the board. The recessed center area between the two pads may form an hourglass shape.

As seen in FIG. 12 the principal features of the contoured profile deck includes a hand grip on the nose 61 such as a nose ridge 122, a hand-hold at two corners of the nose such as a nose gripping node 121, a hand-hold along the two side edges such as side ridges 123, hip lock ridges 125. Here, the nose ridge 122, nose gripping node 121, side ridges 123, and hip lock ridges 125 are connected elements, but can also be made unconnected. The user can grasp the nose ridge 122, nose gripping node 121, and side ridges 123 and can enhance body connection with the board via hip lock ridges 125. Connected elements provide a sleeker aesthetic style.

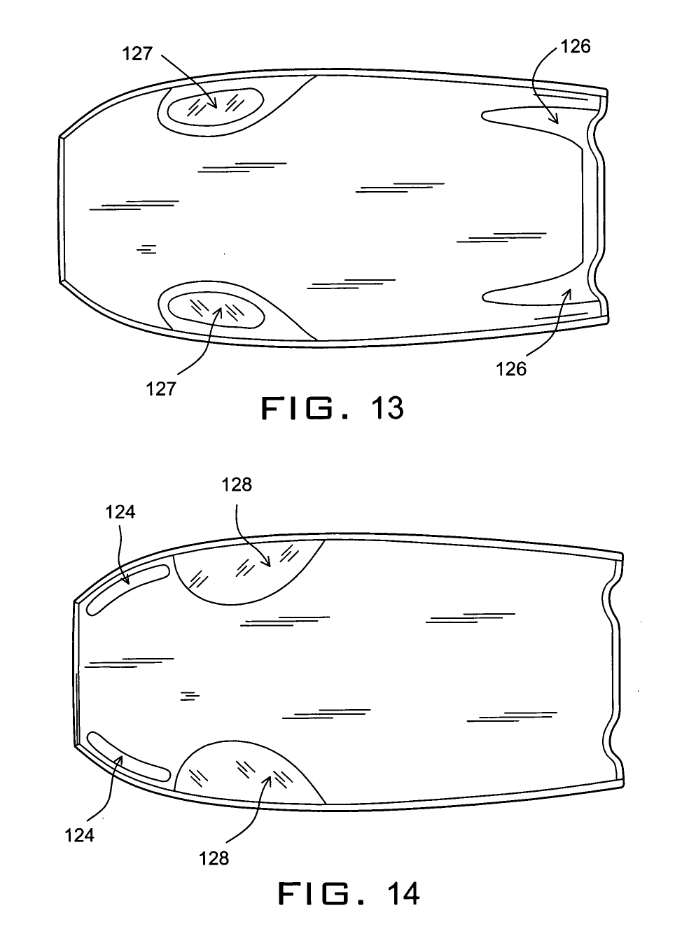

As seen in FIG. 13, the principal features of an alternative embodiment contoured profile deck includes an elbow retainer well 127 providing arm hold and leg depressions 126 providing leg hold. As seen in FIG. 14, the principal features of yet another alternative embodiment contoured profile deck includes side gripping grooves 124, and an elbow pad 128. Side gripping grooves 124, provide hand grip via a thumb and the elbow pad 128 can have a grip surface.

Turning to the concave depression on the slick bottom surface, the theory of operation is speculated as follows: when a rider surfs with a floating device, the friction on the planning surface is a function of the wetted surface area. The concave profile bottom captures air inside the large concave cavity and thus reduces the contact surface area with water. As a result, this reduces friction and increases speed. Therefore the bodyboarder can surf at a higher speed and deliver a longer projection. Prone riding is well known the most often used position to ride a bodyboard. One arm extending forwardly to grip the nose end of the board and the other arm extending along the rider's side to grip on of the board's side edges. When a rider need to make a turn, pushing or pulling against the board's nose end and/or side edges are performed to bend or twist the board. For example, pushing on one side edge will agitate a water flow from one side to the other side and a concave bottom reduces the water flow rate and therefore impedes sideward sliding. It has been found that a concave bottom provides the bodyboard with an incredible hold and reduces sideward sliding when a bodyboarder executes a turn by tilting the board laterally, especially in fast and powerful waves.

The boards in FIGS. 12-14 can be made in a series of manufacturing steps similar to that shown in FIGS. 8 and 9. The top laminated skin is fabricated by the same process in FIG. 8. The top laminated skin is then sized at a cutting station 320 so that its outer edge will extend over the peripheral edge of core 88 enough so that it can be wrapped over, and heat laminated to the top surface and edge surface of the foam core 88. The bottom skin may be made by conventional extrusion process. A polyethylene sheet layer is extruded from another conventional extruder and heat laminated with rollers to polyethylene foam sheet layer 161 fed from bottom roll to produce a bottom laminated skin.

The top foam skin or the bottom foam skin may be imprinted with graphic image for decoration. Printing ink may be applied to the outer surface of the polyolefin foam sheet (161, 71). Alternatively graphic image may be printed on a plastic film and the film is laminated to the outer surface of the polyolefin foam sheet. Additional backing film or foam layers may also be applied between the printed plastic film layer and the polyolefin foam sheet. Additional backing layers may be a plastic film or a binding layer such as adhesive resin layer. One possible printing method is described as follow. First, a polyethylene film layer is imprinted with the desired graphics using a conventional printing process. The polyethylene film layer can be fed from a top roll and polyethylene foam layer fed from a bottom roll. As the film layer and the foam layer are fed from the rolls, hot adhesive resin 201 is extruded, using a conventional extruder, between the film layer and the foam layer to form the laminate layers.

Alternatively, following the printing of the first polyethylene film, a second polyethylene film may be bonded to the graphics imprinted in the first polyethylene film by using conventional glue or adhesive so that the graphic is covered. The first polyethylene film has a thickness of between 0.02 mm and 0.15 mm, and the second polyethylene film has a thickness of between 0.01 mm and 0.15 mm. The resulting dual-layered graphic polyethylene film is similarly laminated to the polyethylene foam sheet by extruding an adhesive resin film layer in between.

The present invention contemplates that many changes and modifications may be made. Therefore, while the presently preferred forms of the improved bodyboard have been shown and described, and several modifications thereof discussed, persons skilled in this art will readily appreciate that various additional changes and modifications may be made without departing from the spirit of the invention, as defined and differentiated by the following claims. The following call out list of elements provides a reference for referencing the elements of the invention.

### CALL OUT LIST OF ELEMENTS

Bodyboard 10
Bottom Finger Bulb 12
Bottom Finger Bulb Hand Depression 14
Shallow Bottom Depression 15

Side laminate layer, lower rail foam skin 20
Lower rail polyolefin foam sheet 21
Board Rear 27
Tail end recess 28
Tail Depression 52
Top laminate Layer, Top foam skin 60
Nose 61
Front Bevel Edge 63
Side Beveled Edge 62
Bottom laminate layer, Bottom foam skin 70
Bottom polyolefin foam sheet 71
Bottom polyolefin film 72
Molded Contour Board Core 88
Press Mold 91, 92
Nose gripping node 121
Nose ridge 122
Side gripping ridge 123
Side gripping grooves 124
Hip lock ridge 125
Leg depression 126
Elbow well 127
Elbow pad 128
Top polyolefin foam sheet, PE foam sheet from roll 161
Adhesive layer 201, 202, 203
Cutting device 320
Laminate top board 340
Nip roller 800
Nip roller resilient exterior softer layer 810

1. A method of laminating a foam skin to a foam core of a sports board for providing a contoured surface profile on at least one primary surface of the sports board, comprising:
molding a foam core having a molded contour surface on at least one primary surface;
applying an adhesive resin film layer to a polyolefin foam skin layer forming a film/foam laminate, the polyolefin foam skin having a thickness in the range from about 1 mm to about 8 mm;
laminating the film side of the film/foam laminate to the contour surface of the molded foam core in a press mold that has the same contour shape as the contour surface of the molded foam core; and
mating the film/foam laminate to the contour surface of the core by applying heat and pressure to the bonding surfaces.

2. The method of claim 1, wherein the contoured surface of the sports board is defined by distinct depressions or raised areas, the depth of said depressions is between 3 mm and 12 mm below the general level of the board surface and the height of said raised areas is between 3 mm and 12 mm above the general level of the board surface.

3. The method of claim 1, further comprising the step of laminating a set of rail skins having the same composite structure as the film/foam laminate to the rails of the foam core includes laminating the film side of the film/foam laminate to the rails of the foam core.

4. The method of claim 1, wherein the polyolefin foam skin is made by laminating a polyolefin film to a polyolefin foam sheet, wherein the polyolefin foam sheet has a higher density than the foam core, wherein the polyolefin film has a thickness ranges from about 0.02 to about 1.5 mm.

5. The method of claim 4, further comprising the step of imprinting graphic images on the polyolefin film for decoration of the sports board.

6. The method of claim 4, further comprising the step of:
imprinting graphic images on the first polyolefin film for decoration of the sports board;
providing a second polyolefin film bonded to the graphic imprinted surface of the first polyolefin film so that the graphic is covered.

7. The sports board of claim 6, wherein the foam core is selected from a plastic foam group consisting of: homopolymer or copolymer of polystyrene foam, polyethylene foam, polypropylene foam, ethylene vinyl acetate foam, Arcel foam, polyvinylchloride foam and polyurethane foam having thickness in the ranges from 0.25 inch to 3 inch.

8. The sports board of claim 6, wherein the polyolefin foam comprises a polyolefin including homopolymer or copolymer of polyethylene and polypropylene, and a blend of two or more of the following members, polyethylene, polypropylene, ethylene vinyl acetate and ethylene butyl acrylate.

9. The method of claim 1, wherein the polyolefin foam skin is made by laminating a plastic film to a polyolefin foam sheet, wherein the plastic film has a thickness in the ranges from 0.02 mm to 0.4 mm and has a coefficient of friction higher than the foam sheet to impede uncontrolled movement of rider on the deck surface of the sports board.

10. The method of claim 2, wherein the contoured surface of the sports board includes depressions or raised areas for providing handhold to rider.

11. The method of claim 2, wherein the contoured surface of the sports board includes a shallow lengthwise bottom depression formed on the bottom surface extending from a location on the board bottom to the tail end, wherein the shallow lengthwise bottom depression is between about 3 mm and about 15 mm deep at a deepest point; and a pair of rear tail depressions formed on the bottom side, each tail depression extending from a deep portion at the tail of the board adjacent to a side edge and gradually blending into the board at approximately one-quarter of the length of the board, wherein the deep the board at approximately one-quarter of the length of the board, wherein the deep portion is no more than 1 cm in depth.

12. The method of claim 2, wherein the contoured surface of the sports board includes a pair of bottom finger bulbs formed on the bottom surface at two corners of the nose end and lower rail side edge to provide a handhold, each finger bulb being a protrusion of a triangular area defined by side edge of the lower rail surface, nose edge extending at a negative angle from one corner to the horizontal portion of the nose edge and a diagonally oriented hand depression line.

13. A method of laminating a foam skin to a foam core of a sports board for providing a contoured surface profile on at least one primary surface of the sports board, comprising:
molding a foam core having a molded contour surface on at least one primary surface;
applying an adhesive resin film layer to a polyolefin foam skin layer forming a film/foam laminate, wherein the polyolefin foam skin has a thickness in the range from about 1 mm to about 8 mm;
laminating the film side of the film/foam laminate to the contour surface of the molded foam core using heat and pressure; wherein the laminating process includes feeding the foam core and the film/foam laminate through a roll-press laminating device; the nip roller on the foam skin side is made of a resilient material that can conform to the contour of the foam core surface when pressing the foam skin against the core surface.

14. The method of claim 13, wherein the contoured surface of the sports board is defined by distinct depressions or raised areas, the depth of said depressions is between 3 mm and 12 mm below the general level of the board surface and the height of said raised areas is between 3 mm and 12 mm above the general level of the board surface.

15. The method of claim 13, further comprising the step of laminating a set of rail skins having the same composite structure as the film/foam laminate to the rails of the foam core includes laminating the film side of the film/foam laminate to the rails of the foam core.

16. The method of claim 13, wherein the polyolefin foam skin is made by laminating a polyolefin film to a polyolefin foam sheet, wherein the polyolefin foam sheet has a higher density than the foam core, wherein the polyolefin film has a thickness ranges from about 0.02 to about 1.5 mm.

17. The method of claim 16, further comprising the step of imprinting graphic images on the polyolefin film.

18. The method of claim 16, further comprising the step of:
imprinting graphic images on the first polyolefin film for decoration of the sports board;
providing a second polyolefin film bonded to the graphic imprinted surface of the first polyolefin film so that the graphic is covered.

19. The sports board of claim 18, wherein the foam core is selected from a plastic foam group consisting of: homopolymer or copolymer of polystyrene foam, polyethylene foam, polypropylene foam, ethylene vinyl acetate foam, Arcel foam, polyvinylchloride foam and polyurethane foam having thickness in the ranges from 0.25 inch to 3 inch.

20. The sports board of claim 18, wherein the polyolefin foam comprises a polyolefin including homopolymer or copolymer of polyethylene and polypropylene, and a blend of two or more of the following members, polyethylene, polypropylene, ethylene vinyl acetate and ethylene butyl acrylate.

21. The method of claim 13, wherein the polyolefin foam skin is made by laminating a plastic film to a polyolefin foam sheet, wherein the plastic film has a thickness in the ranges from 0.02 mm to 0.4 mm and has a coefficient of friction higher than the foam sheet to impede uncontrolled movement of rider on the deck surface of the sports board.

22. The method of claim 14, wherein the contoured surface of the sports board includes depressions or raised areas for providing handhold to rider. depressions or raised areas for providing handhold to rider.

23. The method of claim 14, wherein the contoured surface of the sports board includes a shallow lengthwise bottom depression formed on the bottom surface extending from a location on the board bottom to the tail end, wherein the shallow lengthwise bottom depression is between about 3 mm and about 15 mm deep at the deep point.; and a pair of rear tail depressions formed on the bottom side, each tail depression extending from a deep portion at the tail of the board adjacent to a side edge and gradually blending into the board at approximately one-quarter of the length of the board, wherein the deep portion is no more than 1 cm in depth.

24. The method of claim 14, wherein the contoured surface of the sports board includes a pair of bottom finger bulbs formed on the bottom surface at two corners of the nose end and lower rail side edge to provide a handhold, each finger bulb being a protrusion of a triangular area defined by side edge of the lower rail surface, nose edge extending at a negative angle from one corner to the horizontal portion of the nose edge and a diagonally oriented hand depression line.
